(19) United States
(12) Patent Application Publication
(10) Pub. No.: US 2024/0248178 A1
(43) Pub. Date: Jul. 25, 2024

(54) VEHICLE MOUNTING STRUCTURE FOR RANGING DEVICE, AND RANGING DEVICE

(71) Applicant: DENSO CORPORATION, Kariya-city (JP)

(72) Inventors: Kohei TOYAMA, Kariya-city (JP); Taro BEPPU, Kariya-city (JP)

(21) Appl. No.: 18/628,486

(22) Filed: Apr. 5, 2024

Related U.S. Application Data
(63) Continuation of application No. PCT/JP2022/037456, filed on Oct. 6, 2022.

(30) Foreign Application Priority Data
Oct. 8, 2021 (JP) 2021-166258

(51) Int. Cl. G01S 7/481; G01S 17/931

(52) U.S. Cl. CPC G01S 7/4813; G01S 17/931

(57) ABSTRACT

A vehicle mounting structure for a ranging device includes a ranging device, a bracket, and a shielding plate. The ranging device measures the distance to an object by emitting transmitted waves and detecting reflected waves from the object to which the transmitted wave has been emitted. The bracket attaches the ranging device in a mounting space formed on an outer surface of a vehicle and capable of accommodating the ranging device. The shielding plate covers the mounting space from the outer-surface side of the vehicle with the ranging device attached in the mounting space. The mounting space is provided on at least one of a front surface of the vehicle, a side surface of the vehicle, or a rear surface of the vehicle. The shielding plate forms an opening for introducing into the mounting space traveling wind occurring along with travel of the vehicle.

### CROSS-REFERENCE TO RELATED APPLICATION

The present application is a continuation application of International Application No. PCT/JP2022/037456, filed on Oct. 6, 2022, which claims priority to Japanese Patent Application No. 2021-166258, filed on Oct. 8, 2021. The contents of these applications are incorporated herein by reference in their entirety.

### BACKGROUND

### Technical Field

The present disclosure relates to a vehicle mounting structure for a ranging device, and a ranging device.

### Background Art

There are ranging devices that detect the distance to and the relative speed of an object by emitting transmitted waves and detecting reflected waves resulting from the object to which the transmitted waves has been emitted. These types of devices are used by being mounted to a vehicle and used for detecting various objects present around the vehicle.

### SUMMARY

In the present disclosure, provided is a vehicle mounting structure for a ranging device as the following.

The vehicle mounting structure for the ranging device includes: a ranging device configured to measure a distance to an object; a bracket that attaches the ranging device in a mounting space formed on an outer surface of a vehicle; and a shielding plate that covers the mounting space from an outer-surface side of the vehicle with the ranging device attached in the mounting space, wherein the mounting space is provided on at least one of a front surface, a side surface, or a rear surface of the vehicle, and the shielding plate forms an opening for introducing into the mounting space traveling wind occurring along with travel of the vehicle.

### BRIEF DESCRIPTION OF THE DRAWINGS

FIG. 1 is a perspective view of the appearance of a lidar device.

FIG. 2 is a view illustrating the positions of the lidar device and a mounting space in a vehicle.

FIG. 3 is a view of the lidar device disposed in a front grille and viewed from the front of the vehicle.

FIG. 4 is an enlarged view of a part including the lidar device and a shielding plate in FIG. 3.

FIG. 5 is a perspective view of the lidar device attached in the mounting space without the shielding plate.

FIG. 6 is a sectional view taken along line VI-VI in FIG. 3.

FIG. 7 is a perspective view illustrating a schematic configuration of a bracket.

FIG. 8 is a view of a shielding plate and a lidar device disposed in a front grille and viewed from the front of a vehicle, the shielding plate having formed therein a plurality of through holes functioning as openings.

FIG. 9 is a view of a shielding plate and a lidar device disposed in a front grille and viewed from the front of a vehicle, the shielding plate having formed therein a plurality of slits functioning as openings.

FIG. 10, which corresponds to FIG. 6, is a sectional view of a configuration in which a shielding plate is disposed in such a manner as to entirely cover a mounting space including an area in which a lidar device is positioned.

FIG. 11 is a perspective view of a schematic configuration of a bracket and a shielding plate that are formed of a single component.

FIG. 12 is a perspective view of a lidar device attached in a mounting space without a shielding plate in a configuration in which a breathing filter is disposed on a case of the lidar device.

### DETAILED DESCRIPTION OF THE PREFERRED EMBODIMENTS

Patent Literature 1 discloses a vehicle mounting structure for a ranging device, the vehicle mounting structure being capable of dissipating heat, which is generated in a ranging device disposed on an outer surface of a vehicle, by the flow of air from the interior of the vehicle. Specifically, Patent Literature 1 describes a vehicle mounting structure for a ranging device, the vehicle mounting structure being mainly formed of: a bracket for attaching a ranging device to an outer surface of a vehicle; and a housing disposed on the outer surface of the vehicle to accommodate the ranging device. The vehicle mounting structure for a ranging device includes a first opening and a fan for introducing air-conditioned air in the interior of the vehicle into the housing, and a second opening for discharging air in the housing to the outside. With this configuration, the air-conditioned air in the interior of the vehicle is introduced through the first opening into the housing by the fan, an air flow channel is formed such that the introduced air-conditioned air flows in the housing and is externally discharged through the second opening, and thereby the heat generated in the ranging device is dissipated.

[PTL 1] US 2021/0063093 A

As a result of detailed study, however, the inventor has found a problem that the configuration in Patent Literature 1 needs a fan for introducing air-conditioned air in the interior of the vehicle through the first opening into the housing and therefore the overall size of the vehicle mounting structure for a ranging device is increased. In addition, the number of components is increased due to the fan needed, and the production costs are increased.

According to one aspect of the present disclosure, provided is a technique of improving dissipation of heat generated in a ranging device while reducing the overall size and the production costs of a vehicle mounting structure for the ranging device.

According to one embodiment of the present disclosure, a vehicle mounting structure for a ranging device includes a ranging device, a bracket, and a shielding plate. The ranging device is configured to measure a distance to an object by emitting a transmitted wave and detecting a reflected wave from the object to which the transmitted wave has been emitted. The bracket attaches the ranging device in a mounting space formed on an outer surface of a vehicle and capable of accommodating the ranging device. The shielding plate covers the mounting space from the outer-surface side of the vehicle with the ranging device attached in the mounting space. The mounting space is provided on at least one of a front surface of the vehicle, a side surface of the vehicle, or a rear surface of the vehicle. The shielding plate forms an opening for introducing into the mounting space traveling wind occurring along with travel of the vehicle.

This configuration allows traveling wind occurring along with travel of the vehicle to flow through the opening into the mounting space for the ranging device and therefore air can efficiently be introduced from the outside into the mounting space for the ranging device. Accordingly, it is possible to improve dissipation of heat generated in the ranging device while reducing the overall size and the production costs of the vehicle mounting structure for the ranging device.

Hereinafter, illustrative embodiments of the present disclosure are described with reference to the drawings.

### 1. Configuration

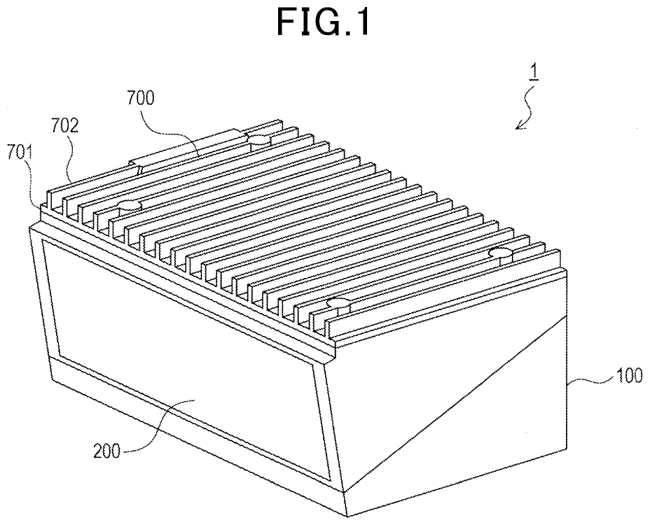

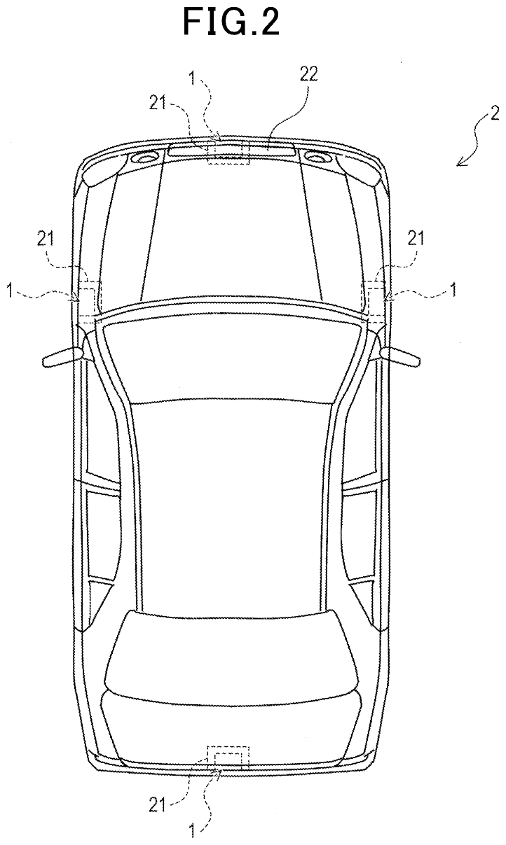

A lidar device 1 illustrated in FIG. 1 is a ranging device that measures the distance to and the relative speed of an object by emitting transmitted light and detecting reflected light resulting from the object to which the transmitted light has been emitted. As illustrated in FIG. 2, the lidar device 1 is used by mounting to a vehicle 2 and used for detecting various objects present around the vehicle 2. The lidar may also be written as LiDAR. LiDAR is an abbreviation of Light Detection and Ranging.

On an outer surface of the vehicle 2, a mounting space 21 capable of accommodating the lidar device 1 is formed, and the lidar device 1 is disposed in the mounting space 21. The mounting space 21 is provided on a front surface, a side surface, or a rear surface of the vehicle 2. FIG. 2 illustrates the position on the front surface, the side surface, and the rear surface of the vehicle 2 at which the mounting space 21 is provided. That is, the mounting space 21 is provided at least on the front surface, the side surface, or the rear surface of the vehicle 2, and, for example, may be provided at two locations, i.e., the front surface and the rear surface of the vehicle 2 or may be provided at four locations, i.e., the front surface, both side surfaces, and the rear surface of the vehicle 2. In the present embodiment, the mounting space 21 is, as described later, provided in a front grille 22 on the front surface of the vehicle 2. A structure for mounting the lidar device 1 on the vehicle 2, specifically a vehicle mounting structure for the lidar device 1 is described later in detail, the structure including the lidar device 1, and a bracket 31 and a shielding plate 32 described later, to be disposed in the mounting space 21.

Referring back to FIG. 1, the lidar device 1 includes a case 100, an optical window 200, and a heat sink 700.

The case 100 is a resin or metal box having one open side and formed in the shape of a rectangular parallelepiped.

The optical window 200 is formed of a material that permits transmitted light and reflected light to pass therethrough and disposed in such a manner as to cover an opening portion of the case 100. The surface of the case 100 on which the optical window 200 is disposed is a surface of the case 100 that permits transmitted light and reflected light to pass therethrough, and the surface is defined as a front surface, and the surface opposite from the front surface is defined as a back surface.

The case 100 has an internal space that accommodates components for measuring the distance to and the relative speed of an object. The components for measuring the distance and the relative speed are specifically a phototransmitter, a photoreceiver, a scanner, and the like. The phototransmitter outputs transmitted light. The photoreceiver receives reflected light from an object to which the transmitted light has been emitted and converts the reflected light to an electric signal. The scanner includes a deflecting mirror that is rotationally driven and reflects transmitted light and reflected light in the direction corresponding to the rotational angle of the deflecting mirror. The transmitted light output from the phototransmitter is deflected and scanned by the scanner, and emitted in a preset scanning range. The reflected light from an object to which the transmitted light has been emitted is detected by the photoreceiver.

The heat sink 700 is disposed on an outer surface of the case 100 in order to dissipate heat generated by the components and the like accommodated in the internal space of the case 100. The heat sink 700 has a general shape including a plurality of fins 702 standing upright on a tabular base 701. The shape of the heat sink may have a shape other than the shape including the fins 702 standing upright, and may have, for example, a shape including a plurality of pins standing upright on a tabular base. The pins are thin cylindrical members extending in the direction away from the base. The heat sink 700 is disposed on a surface other than the front surface of the case 100. In the present embodiment, the heat sink 700 is disposed on an upper surface of the case 100. The heat sink 700 is disposed such that the fins 702 extend in the direction along the flow of traveling wind flowing in through an opening described later (in the present embodiment, the direction from the front surface toward the back surface of the case 100).

Next, a vehicle mounting structure for the lidar device 1 is described. A vehicle mounting structure for the lidar device 1 includes the lidar device 1, a bracket 31, and a shielding plate 32. Hereinafter, described as an example is a vehicle mounting structure having a configuration of the present embodiment in which the lidar device 1 is disposed on the front surface of the vehicle 2. The vehicle mounting structure for the lidar device 1, however, has the same configuration in any of the cases where the lidar device 1 is disposed on the front surface, the side surface, or the rear surface of the vehicle 2.

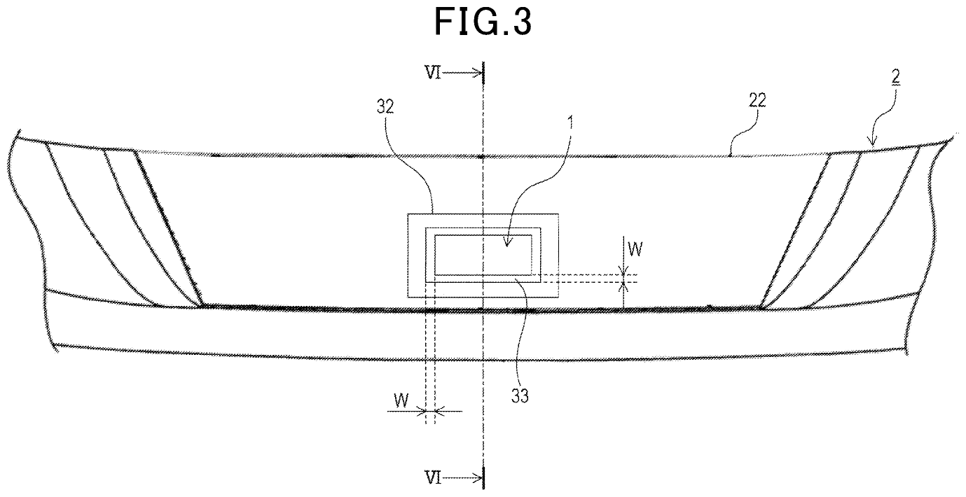

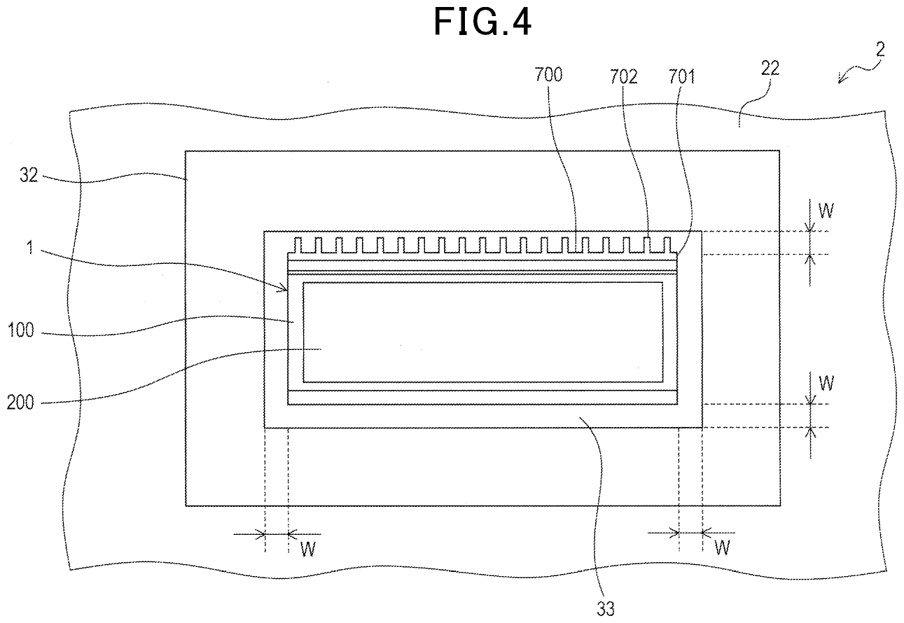

As illustrated in FIGS. 3 and 4, the lidar device 1 is disposed in the front grille 22 on the front surface of the vehicle 2. The lidar device 1 is disposed in the front grille 22 such that the front surface of the case 100 through which transmitted light and reflected light pass is exposed to the outside of the vehicle.

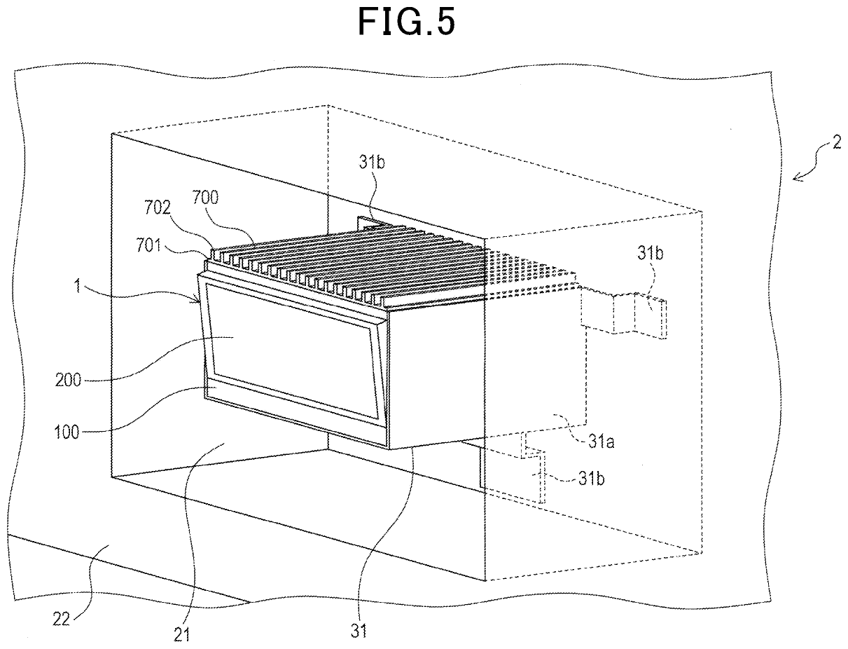

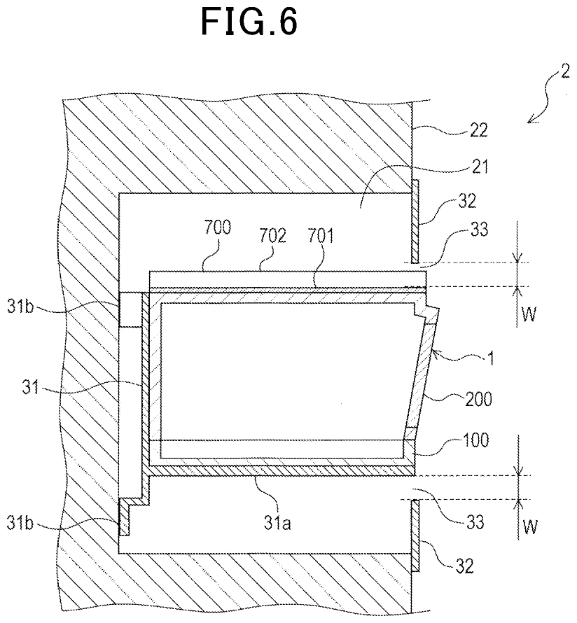

As illustrated in FIGS. 5 and 6, the front grille 22 has formed therein the mounting space 21 for the lidar device 1. More specifically, the front grille 22 includes a recess having an internal space of a size capable of accommodating the lidar device 1 and the internal space of the recess is the mounting space 21 for the lidar device 1. In FIG. 5, the recess is a rectangular parallelepiped-shaped recessed portion in the front grille 22, and the mounting space 21 is a rectangular parallelepiped-shaped space that is the internal space of the recess. The lidar device 1 is attached in the mounting space 21 with the bracket 31 such that the position of the front surface of the case 100 is substantially the same as the position of an opening portion of the recess. The sectional view in FIG. 6 does not illustrate the components accommodated in the internal space of the case 100 of the lidar device 1.

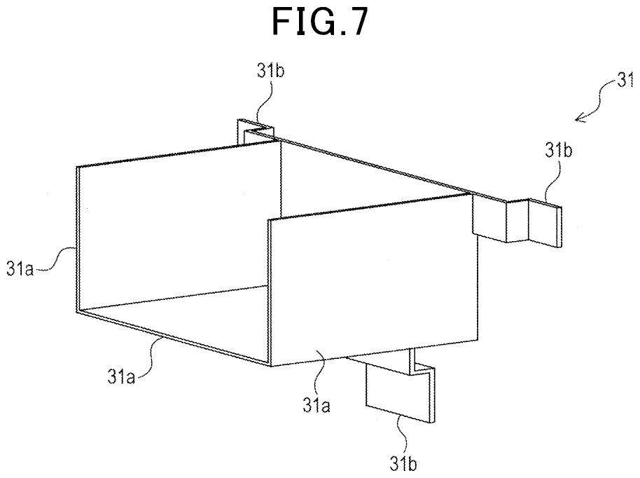

A structure of the bracket 31 is described with reference to FIG. 7. The bracket 31 is a member for attaching the lidar device 1 in the mounting space 21. The bracket 31 includes a retention part 31a that is a part being in contact with the lidar device 1 and retaining the lidar device 1, and an attachment part 31b that is a part attached to an inner surface of the mounting space 21. In the present embodiment, the retention part 31a includes three tabular parts respectively in contact with both side surfaces and the lower surface of the lidar device 1, and these three parts fix the lidar device 1 and thereby retain the lidar device 1. The shape of the retention part 31a is not limited to this example, and any shape can be acceptable as long as the retention part 31a is configured to enable the lidar device 1 to be fixed to the bracket 31. In the present embodiment, the attachment part 31b includes parts respectively extending from the three parts of the retention part 31a and being in contact with a surface of the inner surfaces of the mounting space 21 to which the bracket 31 is attached. The attachment part 31b is fixed to the inner surface of the mounting space 21. The shape of the attachment part 31b is not limited to this example, and any shape can be acceptable as long as the attachment part 31b is configured to enable the bracket 31 to be fixed to the inner surface of the mounting space 21. As illustrated in FIGS. 5 and 6, the attachment part 31b of the bracket 31 is fixed to the inner surface of the mounting space 21 and the lidar device 1 is fixed to the retention part 31a of the bracket 31, and thereby the lidar device 1 is attached in the mounting space 21.

As illustrated in FIGS. 3, 4, and 6, the shielding plate 32 is a tabular member that covers the mounting space 21 from the outer-surface side of the vehicle 2 with the lidar device 1 attached in the mounting space 21. Specifically, the outer shape of the shielding plate 32 is a rectangular shape, and the shielding plate 32 is a frame-shaped tabular material having formed in a central portion thereof a hole portion that is a rectangular hole. The shielding plate 32 is configured to have an outer size the same as the opening portion of the recess forming the mounting space 21 or larger than the opening portion of the recess, and to have an inner size larger than at least the optical window 200. With the shielding plate 32 disposed in such a manner as to cover the mounting space 21, at least the optical window 200 is exposed from the hole portion of the shielding plate 32 to the outside of the vehicle. In the present embodiment, the hole portion of the shielding plate 32 is formed larger than the outer size of the front surface of the lidar device 1. The front surface of the lidar device 1 is the same surface as the front surface of the case 100 of the lidar device 1, and in the description, the outer size of the front surface of the lidar device 1 does not include the fins 702 of the heat sink 700 (that is, the outer size includes the heat sink 700 but up to the base 701). That is, the outer edge on the front surface of the lidar device 1 is defined as the outer edge of a portion not including the fins 702 of the heat sink 700 (that is, a portion up to the base 701 of the heat sink 700). Specifically, the outer edge on the front surface of the lidar device 1 illustrated in FIG. 4 is the outer edge of a rectangular portion from the case 100 of the lidar device 1 up to the base 701 of the heat sink 700, and the outer size of the rectangular portion is the outer size of the front surface of the lidar device 1. Therefore, with the shielding plate 32 disposed in such a manner as to cover the mounting space 21, the front surface of the lidar device 1 is exposed from the hole portion of the shielding plate 32 to the outside of the vehicle. That is, the shielding plate 32 is disposed in such a manner as to cover the opening portion of the recess from the outer-surface side but avoid the place in which the lidar device 1 (more specifically, the case 100 and the base 701 of the heat sink 700) is positioned. In other words, the shielding plate 32 covers, from the outer-surface side of the vehicle 2, the mounting space 21, except an area of the mounting space 21 in which the lidar device 1 (more specifically, the case 100 and the base 701 of the heat sink 700) is positioned.

The shielding plate 32 forms an opening for introducing into the mounting space 21 traveling wind occurring along with travel of the vehicle 2. The opening formed by the shielding plate 32 is described as follows.

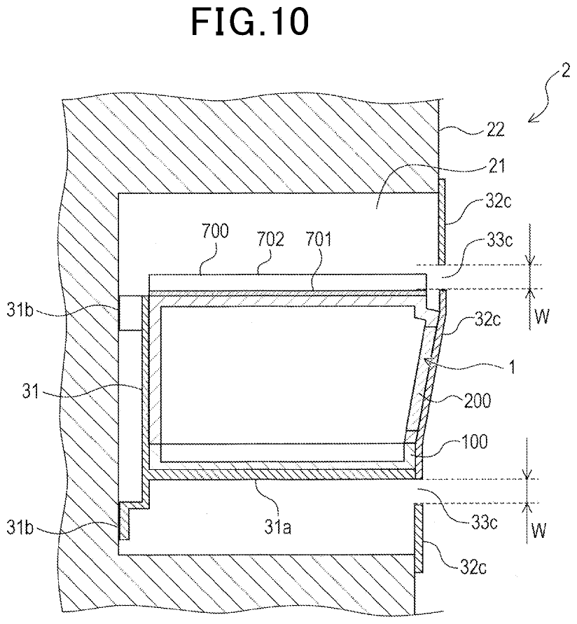

In the present embodiment, the shielding plate 32 is configured to form a gap 33 between the shielding plate 32 and the lidar device 1, and the gap 33 formed between the shielding plate 32 and the lidar device 1 functions as the opening. As described above, in the present embodiment, the hole portion of the shielding plate 32 is larger than the outer size of the front surface of the lidar device 1, and therefore the gap 33 is formed between the inner edge of the shielding plate 32 (that is, the outer periphery of the hole portion) and the lidar device 1. Specifically, the gap 33 having a predetermined width W is formed on the entire periphery around the lidar device 1 between the shielding plate 32 and the lidar device 1 as viewed from the direction perpendicular to the shielding plate 32 (in the case of the present embodiment, from the front of the vehicle 2). The gap 33 between the shielding plate 32 and the lidar device 1 is, as illustrated in FIGS. 4 and 6, more specifically the gap 33 between the inner edge of the shielding plate 32 and the outer edge on the front surface of the lidar device 1. That is, on the disposition surface of the lidar device 1 (in the present embodiment, the upper surface of the lidar device 1) on which the heat sink 700 is disposed, the gap 33 having the width W is formed between the shielding plate 32 and the base 701 of the heat sink 700. On the surfaces other than the disposition surface of the lidar device 1 on which the heat sink 700 is disposed, the gap 33 having the width W is formed between the shielding plate 32 and the case 100. In FIGS. 4 and 6, the width W of the gap 33 is shown wider in order to describe the formation of the gap 33 having the width W between the shielding plate 32 and the lidar device 1 and to facilitate understanding of such formation. That is, in some configurations of the shielding plate 32 and the lidar device 1, the length of the width W of the gap 33 between the shielding plate 32 and the base 701 of the heat sink 700 is shorter than the length of the fins 702, and the shielding plate 32 and the fins 702 partially overlap with each other as viewed from the direction perpendicular to the shielding plate 32. In this case, the gap 33 between the shielding plate 32 and the lidar device 1 on the disposition surface on which the heat sink 700 is disposed is the gap 33 between two adjacent fins of the fins 702 and between the shielding plate 32 and the base 701 of the heat sink 700 as viewed from the direction perpendicular to the shielding plate 32. In also FIG. 10 that corresponds to FIG. 6 and is described later, a width W of a through hole 33C is shown wider similarly to FIGS. 4 and 6.

The gap 33 formed between the shielding plate 32 and the lidar device 1 is not necessarily formed on the entire periphery around the lidar device 1. For example, the shielding plate may be configured to form the gap having the predetermined width W between the shielding plate and the lidar device 1 only at the upper-side portion (that is, the portion on the side of the disposition surface on which the heat sink 700 is disposed) of the periphery of the lidar device 1 as viewed from the direction perpendicular to the shielding plate.

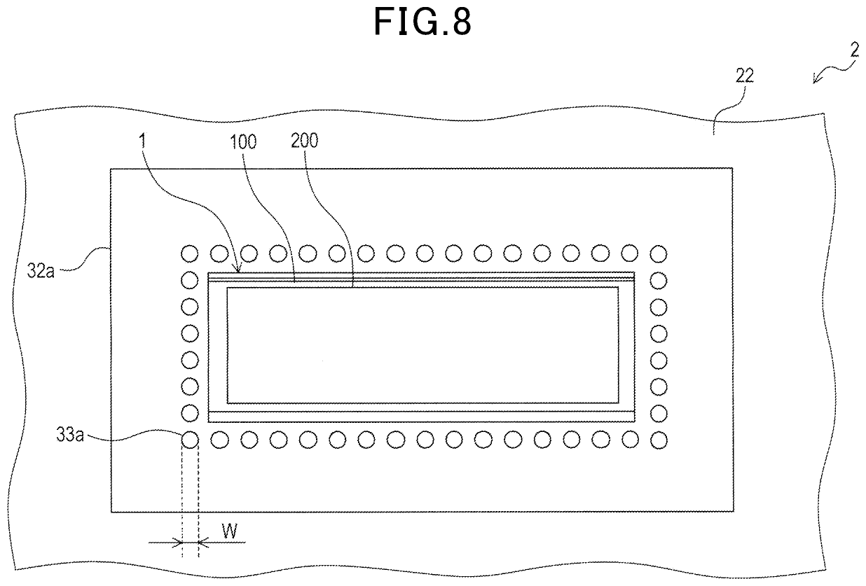

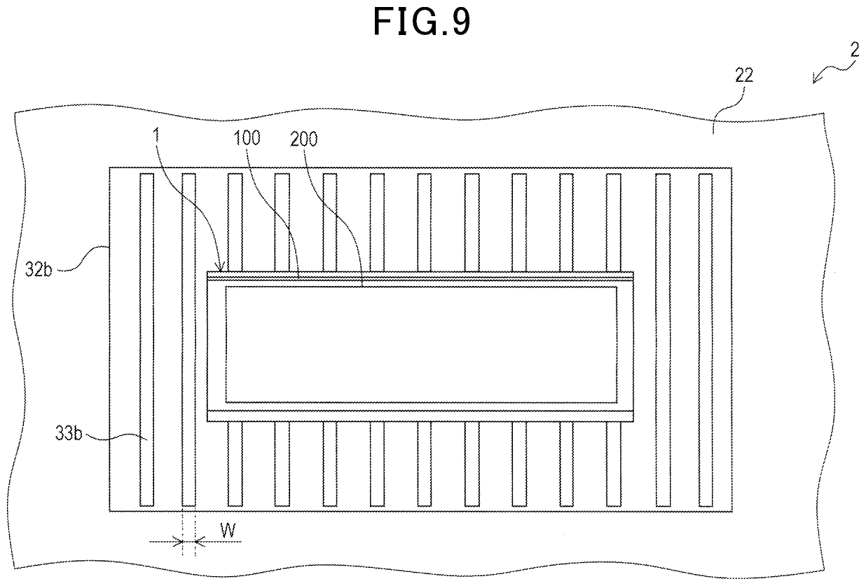

In the present embodiment, the gap 33 formed between the shielding plate 32 and the lidar device 1 functions as an opening as described above, but the shielding plate may be configured to have formed therein a through hole functioning as the opening. When the through hole formed in the shielding plate functions as the opening, the gap functioning as the opening need not be formed between the shielding plate and the lidar device 1. For example, as illustrated in FIG. 8, a gap functioning as the opening is not formed between a shielding plate 32a and the lidar device 1, but the shielding plate 32a has a plurality of through holes 33a formed therein. Thus, the shielding plate may be configured to include these plurality of through holes 33a functioning as the openings. The shielding plate 32a illustrated in FIG. 8 is configured to include the plurality of through holes 33a each having a circular shape with a diameter W, with the plurality of through holes 33a arranged along the outer periphery of the lidar device 1 as viewed from the direction perpendicular to the shielding plate 32a. The through holes formed in the shielding plate may be, as illustrated in FIG. 9, slits 33b formed in a shielding plate 32b. The shielding plate 32b illustrated in FIG. 9 is configured to include the plurality of slits 33b having a predetermined width W, with the slits 33b extending in the vertical direction and arranged in the horizontal direction at certain intervals as viewed from the direction perpendicular to the shielding plate 32b. Also in the configuration illustrated in FIG. 9, a gap functioning as the opening is not formed between the shielding plate 32b and the lidar device 1, but the shieling plate 32b has formed therein the plurality of slits 33b functioning as the openings.

The shape of the through holes formed in the shielding plate is not limited to the circular shape or the slit described above, but the through holes can be formed in any shape. For example, the shape of the through holes may be a shape formed in consideration of designability, such as a shape in harmony with the design of the front grille 22, or may be a shape formed in consideration of heat dissipation performance.

The shielding plate 32, 32a, 32b is configured such that the opening has a width of 0.5 mm to 4 mm. The width W of the opening is the minimum dimension among dimensions representing the size of the opening. For example, in cases where the opening has a shape extending with a constant width (for example, the gap 33 formed between the shielding plate 32 and the lidar device 1 and having the predetermined width as illustrated in FIG. 4, and the slit 33b formed in the shielding plate 32b and having the predetermined width as illustrated in FIG. 9), the length of the constant width is the width of the opening. In cases where the opening does not have a shape extending with a constant width, for example, when a through hole formed in the shielding plate functions as the opening and the through hole is, as illustrated in FIG. 8, the through hole 33a having a circular shape, the length of the diameter of the through hole 33a is the width of the opening. When the through hole has an ellipse shape, the length of the minor axis of the through hole is the width of the opening. That is, the opening having a width W of 0.5 mm to 4 mm means, in other words, the opening being configured to have a size such that a ball having a diameter of 0.5 mm can pass therethrough but a ball having a diameter of more than 4 mm cannot pass therethrough.

### 2. Effects

The first embodiment described above in detail can give the following effects.

(2a) A vehicle mounting structure for a lidar device 1 includes a lidar device 1, a bracket 31, and a shielding plate 32. The lidar device 1 is attached with the bracket 31 in a mounting space 21 provided on a front surface, a side surface, or a rear surface of a vehicle 2. A shielding plate 32 is disposed in such a manner as to cover the mounting space 21 from the outer-surface side of the vehicle 2 with the lidar device 1 attached in the mounting space 21. The shielding plate 32 forms an opening for introducing into the mounting space 21 traveling wind occurring along with travel of the vehicle 2. This configuration allows traveling wind occurring along with travel of the vehicle 2 to flow through the opening into the mounting space 21 for the lidar device 1 and therefore air can efficiently be introduced from the outside into the mounting space 21 for the lidar device 1. In addition, due to such a simple configuration as providing an opening in the shielding plate 32, the number of components can be reduced compared with, for example, the vehicle mounting structure for a ranging device described in the prior art document, the vehicle mounting structure being configured to include a fan for introducing air from the outside into a mounting space for a lidar device. Therefore, this simple configuration can suppress an increase in the overall size of the vehicle mounting structure. Accordingly, it is possible to improve dissipation of heat generated in the lidar device 1 while reducing the overall size and the production costs of the vehicle mounting structure for the lidar device 1.

(2b) The shielding plate 32, 32a, 32b is configured such that the opening has a width W of 0.5 mm to 4 mm. In this configuration, the size of the opening is small enough to suppress entry of foreign matter into the mounting space 21 and large enough to introduce traveling wind into the mounting space 21 so that the heat dissipation can be improved, and therefore it is possible to efficiently obtain a heat dissipation effect while suppressing entry of foreign matter. When the width W of the opening is set to 0.5 mm to 2 mm, the heat dissipation efficiency is particularly good. In addition, such setting results in formation of a small opening and therefore an adverse effect on designability caused by the formation of an opening can be reduced.

(2c) The opening may be a through hole 33a, 33b formed in the shielding plate 32a, 32b. In this configuration, the opening can be formed in a desired shape. For example, by changing the shape of the through hole in harmony with the design of a front grille, the opening can be formed in a shape in harmony with the design of any of various front grilles. By forming the opening in a shape in harmony with the design of a front grille, it is possible to increase the designability while obtaining the heat dissipation effect brought about by introducing traveling wind into the mounting space 21. The shape of the opening can also be changed according to the purpose, such as changing the shape of the through hole and thus forming the opening in such a shape as to increase the heat dissipation performance.

(2d) The lidar device 1 includes a heat sink 700 disposed on a surface other than a front surface of a case 100. In this configuration, the heat sink 700 easily allows heat generated by the components accommodated in an internal space of the case 100 to be dissipated into the mounting space 21. Accordingly, it is possible to further improve the heat dissipation of the components accommodated in the internal space of the case 100 together with the above-described introduction of traveling wind through the opening into the mounting space 21.

In the present embodiment, the lidar device 1 corresponds to a ranging device, and the transmitted wave corresponds to transmitted light, and the reflected wave corresponds to reflected light.

### 3. Other Embodiments

As described above, the embodiment of the present disclosure has been described. Needless to say, however, the present disclosure is not limited to the embodiment and various embodiments can be employed.

(3a) In the embodiment, the shielding plate 32, 32a, 32b is configured such that the opening has a width W of 0.5 mm to 4 mm. The size of the opening, however, is not limited to this range. The width of the opening may be set to, for example, 0.4 mm or 4.5 mm.

(3b) In the embodiment, the cases have been illustrated where the gap 33 formed between the shielding plate 32 and the lidar device 1 functions as an opening, and where the through hole 33a, 33b formed in the shielding plate 32a, 32b functions as an opening. The configuration of the opening, however, is not limited to these cases. For example, a configuration may be employed in which both the gap formed between the shielding plate and the lidar device and the through hole formed in the shielding plate are provided so as to function as openings.

(3c) In the embodiment, the shielding plate 32 is configured to cover, from the outer-surface side of the vehicle 2, the mounting space 21, except an area of the mounting space 21 in which the lidar device 1 is positioned. The configuration of the shielding plate, however, is not limited to this configuration. For example, as illustrated in FIG. 10, a shielding plate 32c may be made from a material that can permit transmitted light and reflected light to pass therethrough and configured to entirely cover the mounting space 21 including the area in which the lidar device 1 is positioned. That is, the shielding plate 32c covers the mounting space 21 in such a manner as to cover at least the area of the mounting space 21 in which the lidar device 1 is positioned as viewed from the direction perpendicular to the shielding plate 32c, such that the whole of the lidar device 1 is concealed by the shielding plate 32c. Specifically, the shielding plate 32c is a tabular member that covers the whole of the mounting space 21 and has a through hole 33c formed therein, and the through hole 33c is formed in an area other than the area of the mounting space 21 in which the lidar device 1 is positioned as viewed from the direction perpendicular to the shielding plate 32c. The area in which the lidar device 1 is positioned is more specifically an area in which a portion of the lidar device 1 other than the fins 702 of the heat sink 700 is positioned. The through hole 33c functions as an opening in the shielding plate 32c. The shape of the through hole 33c in the shielding plate 32c illustrated in FIG. 10 is more specifically described. The through hole 33c is, as viewed from the direction perpendicular to the shielding plate 32c, formed at the same position as the gap formed between the shielding plate 32 and the lidar device 1 and having the predetermined width W in the embodiment. That is, the through hole 33c having the predetermined width W is formed on the substantially entire periphery around the lidar device 1 as viewed from the direction perpendicular to the shielding plate 32c. The inside and the outside of the through hole 33c in the shielding plate 32c are partially connected to each other. This configuration enables traveling wind occurring along with travel of the vehicle 2 to be introduced through the opening into the mounting space 21 while making the shielding plate 32c conceal the whole of the lidar device 1 disposed in the mounting space 21. Accordingly, the lidar device 1 can be mounted on the vehicle 2 in a concealed manner such that the lidar device 1 is less obvious from the outside of the vehicle, and therefore the designability is increased and the heat dissipation performance can also be increased.

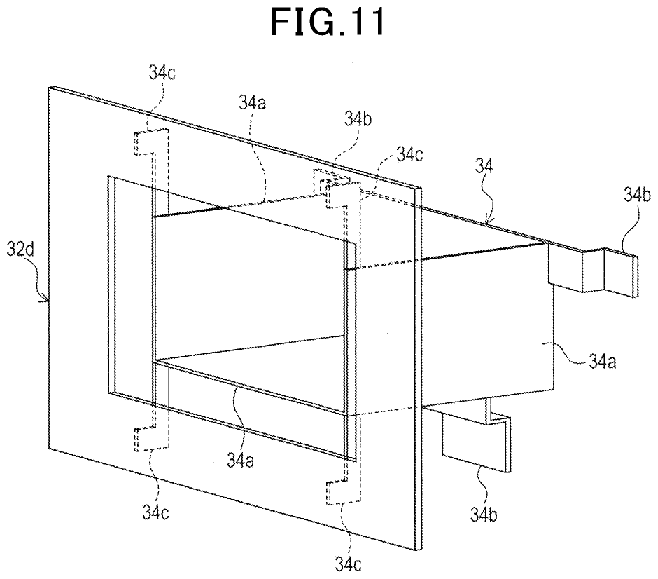

(3d) In the embodiment, the bracket 31 and the shielding plate 32 are separate components. As illustrated in, for example, FIG. 11, however, a bracket 34 and a shielding plate 32d may be formed of a single component. The bracket 34 illustrated in FIG. 11 includes a retention part 34a that is a part having the same shape as the bracket 31 in the embodiment and retaining the lidar device 1, and an attachment part 34b that is a part attached to an inner surface of the mounting space 21. Further, the bracket 34 includes a connector 34c that is a part extending from an end, close to the shielding plate 32d, of the retention part 34a and connected to the rear surface of the shielding plate 32d. That is, the shielding plate 32d and the bracket 34 are connected via the connector 34c, and the shielding plate 32d and the bracket 34 are formed as a single component. The shielding plate 32d has the same shape as the shielding plate 32 in the embodiment except that the rear surface of the shielding plate 32d is connected to the connector 34c. The lidar device 1 is disposed in the retention part 34a of the bracket 34 and the attachment part 34b of the bracket 34 is attached to an inner surface of the mounting space 21, with the lidar device 1 fixed to the retention part 34a, and thereby the lidar device 1, the bracket 34, and the shielding plate 32d are attached to the vehicle 2. In this configuration, the bracket 34 and the shielding plate 32d are formed of a single component and therefore the number of components can be reduced.

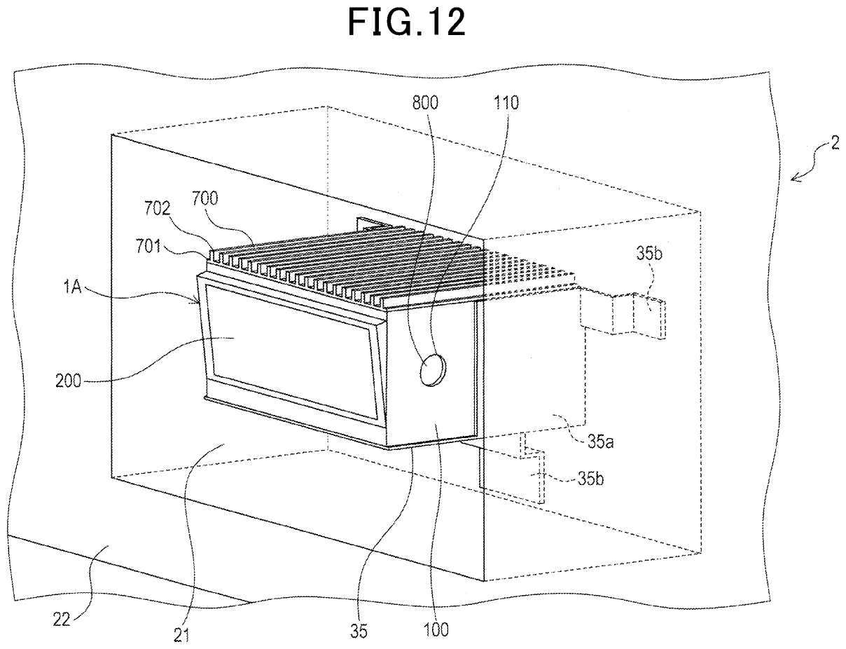

(3e) As illustrated in FIG. 12, a lidar device 1A may be configured to have a connection portion 110 formed therein, the connection portion 110 connecting, to the outside, the internal space of the case 100 that accommodates the components for measuring the distance, and to include a breathing filter 800 in the connection portion 110. The breathing filter 800 is attached to the case 100 in such a manner as to block the connection portion 110, and is configured to enable ventilation between the internal space and the outside via the connection portion 110 while suppressing intrusion of a liquid into the internal space of the case 100. The liquid that can be presumed is, for example, rainwater, water used for car washing, water splattered during travel of the vehicle, a snow-melt solution of calcium chloride used as a snow-melting agent, and an organic solvent such as brake oil. The breathing filter 800 is also referred to as a vent filter. A bracket 35 includes a retention part 35a that is a part retaining the lidar device 1A, and an attachment part 35b that is a part attached to an inner surface of the mounting space 21, the retention part 35a and the attachment 35b having basically the same shape as those of the bracket 31 in the embodiment, but the retention part 35a is configured not to cover the breathing filter 800. For example, in cases where the breathing filter 800 is disposed on a side surface of the case 100 as in the configuration illustrated in FIG. 12, the retention part 35a is formed in such a manner as to avoid the place in which the breathing filter 800 is positioned and to be in contact with the side surface on which the breathing filter 800 is disposed. This configuration enables traveling wind flowing through the opening into the mounting space 21 to be introduced through the breathing filter 800 into the internal space of the case 100 while preventing intrusion of a liquid from the outside into the case 100. Therefore, it is possible to further improve the heat dissipation of the components accommodated in the internal space of the case 100. In addition, it is possible to release the pressure on the internal space of the case 100 to the outside and reduce the stress on each of the components accommodated in the internal space of the case 100. Therefore, it is possible to suppress a decrease of ranging accuracy caused by the stress on each of the components accommodated in the internal space of the case 100. For example, in cases of a lidar device, there is a concern about a decrease of ranging accuracy when distortion or the like caused by the stress is generated in the optical system. This configuration, however, can suppress a decrease of ranging accuracy caused by the stress.

(3f) In the embodiment, the heat sink 700 is disposed on the upper surface of the case 100, but the disposition surface on which the heat sink 700 is disposed is not limited to this surface. For example, the heat sink 700 may be disposed on a side surface, a lower surface, or a back surface of the case 100. For good heat dissipation efficiency, the heat sink 700 is disposed on a surface other than the back surface of the case 100. In addition, in order to increase the heat dissipation efficiency, the heat sink 700 is preferably disposed such that the fins 702 extend in the direction along the flow of traveling wind flowing in through the opening.

Further, for example, the heat sink 700 may be disposed on a plurality of surfaces except the front surface of the case 100, such as the upper surface and the side surface of the case 100, and the upper surface and the lower surface of the case 100.

(3g) In the vehicle mounting structure for a lidar device, a shape for promoting convection may be provided in the mounting space 21. Specifically, a shape for promoting convection may be provided on at least one of an inner surface of the mounting space 21 (that is, the vehicle 2) and the bracket 31. For example, as the shape for promoting convection, a chamfered portion may be provided on a corner of the mounting space 21 by performing C chamfering or R chamfering. Alternatively, for example, a rib structure may be provided on a surface along the traveling-wind flow-in direction in the mounting space 21, the rib structure including a plurality of ribs that extend in the direction orthogonal to the traveling-wind flow-in direction and are arranged in the traveling-wind flow-in direction. The plurality of ribs in the rib structure may be, for example, configured such that the counter surfaces of two adjacent ribs are gently inclined in such a manner as to be separated from each other toward the tips of the ribs and an air flow is generated between the two adjacent ribs. By providing this shape for promoting convection, the convection of air in the mounting space 21 is promoted and the heat dissipation effect can be expected to be increased.

(3h) In the embodiment, the lidar device 1 is illustrated as a ranging device, but the type of the ranging device is not limited to this lidar device. For example, the ranging device may be a millimeter wave radar.

(3i) In the embodiment, the case 100 is configured to include the heat sink 700, but may be configured not to include the heat sink 700.

(3j) The functions of one constituent element in the embodiment may be spread into a plurality of constituent elements, or the functions of a plurality of constituent elements may be integrated into one constituent element. Alternatively, a part of the configurations in the embodiment may be omitted. Further, at least a part of the configurations in the embodiment may be, for example, supplement or replace the configuration of any of the other embodiments.

What is claimed is:

1. A vehicle mounting structure for a ranging device, the vehicle mounting structure comprising:
a ranging device configured to measure a distance to an object by emitting a transmitted wave and detecting a reflected wave from the object to which the transmitted wave has been emitted;
a bracket that attaches the ranging device in a mounting space formed on an outer surface of a vehicle and capable of accommodating the ranging device; and
a shielding plate that covers the mounting space from an outer-surface side of the vehicle with the ranging device attached in the mounting space, wherein
the mounting space is provided on at least one of a front surface of the vehicle, a side surface of the vehicle, or a rear surface of the vehicle, and
the shielding plate forms an opening for introducing into the mounting space traveling wind occurring along with travel of the vehicle.

2. The vehicle mounting structure for the ranging device according to claim 1, wherein
the opening has a width of 0.5 mm to 4 mm.

3. The vehicle mounting structure for the ranging device according to claim 1, wherein
the opening includes a through hole formed in the shielding plate.

4. The vehicle mounting structure for the ranging device according to claim 1, wherein
the shielding plate is made from a material that permits the transmitted wave and the reflected wave to pass therethrough, and entirely covers the mounting space including an area in which the ranging device is positioned.

5. The vehicle mounting structure for the ranging device according to claim 1, wherein
the bracket and the shielding plate are formed of a single component.

6. The vehicle mounting structure for the ranging device according to claim 1, wherein
the ranging device includes:
a case having an internal space that accommodates a component for measuring the distance, and having formed therein a connection portion that connects the internal space with an outside; and
a breathing filter disposed in the connection portion.

7. The vehicle mounting structure for the ranging device according to claim 1, wherein
the ranging device includes:
a case that accommodates a component for measuring the distance; and
a heat sink that is disposed on a surface of the case other than a surface through which the transmitted wave and the reflected wave pass.

8. A ranging device which is the ranging device mounted on the vehicle, the vehicle comprising the vehicle mounting structure for the ranging device according to claim 1.
